(19) United States
(12) Patent Application Publication
(10) Pub. No.: US 2021/0237016 A1
(43) Pub. Date: Aug. 5, 2021

(54) PORTABLE REACTOR LOADING STATION FOR VIBRATIONAL LOADING OF PILOT PLANT REACTOR TUBES

(71) Applicant: Saudi Arabian Oil Company, Dhahran (SA)

(72) Inventors: Khalid Saud Al-Shuker, Dhahran (SA); Stuart N. Leach, Dhahran (SA); Daniel C. Longstaff, Dhahran (SA)

(21) Appl. No.: 16/782,643

(22) Filed: Feb. 5, 2020

(51) Int. Cl. B01J 8/16; B01J 8/06; B01J 8/00

(52) U.S. Cl. CPC B01J 8/16; B01J 2208/00752; B01J 8/002; B01J 8/06

(57) ABSTRACT

A system for vibrational loading is provided. The system includes: one or more pilot plant reactor tubes; at least one vibrator attached to and configured to impart vibrational energy to a corresponding at least one of the reactor tubes during the vibrational loading; and a portable reactor loading station. The loading station includes: a base structure; a plurality of rolling members attached to the base structure which is configured to contact and roll across a horizontal surface while remaining attached to the base structure and separate the base structure from the horizontal surface; a frame attached to and extending vertically from the base structure; and one or more clamps attached to the frame to secure the reactor tubes in a vertical orientation. The clamps are attached to the frame through corresponding elastomeric members vibrationally isolating the secured reactor tubes from the frame during the vibrational loading.

### FIELD OF THE DISCLOSURE

The present disclosure relates to a portable reactor loading station for vibrational loading of pilot plant reactor tubes, and to a method of vibrational loading of pilot plant reactor tubes using a portable reactor loading station.

### BACKGROUND OF THE DISCLOSURE

Various commercial scale chemical processes are conducted using continuous flow reactor vessels loaded with a solid catalyst. In these reactors, fluid consisting of gas, liquid, or a mixture of gas and liquid is fed into the reactor inlets. This feed fluid flows though the solid catalyst, which causes a portion of the chemical components in the feed to chemically convert to the desired products of the process. Exactly what portion of the feed converts to the desired products depends on many factors, especially the type of catalyst used. Although different catalysts may physically have the same appearance, and may have similar or even identical chemical compositions, their performance in the chemical process can vary widely. Even small differences in catalyst performance can have a significant difference in the economic impact of a commercial process. For instance, a 0.5% difference in performance can provide a significant economic benefit when applied commercially. However, there are a number of challenges to measuring the performance of different catalysts in a commercial setting.

It is in regard to these and other problems in the art that the present disclosure is directed to provide a technical solution for an effective portable reactor loading station for vibrational loading of pilot plant reactor tubes, and for an effective method of vibrational loading of pilot plant reactor tubes using a portable reactor loading station.

### SUMMARY OF THE DISCLOSURE

According to an embodiment, a portable reactor loading station for vibrational loading of pilot plant reactor tubes is provided. The loading station comprises: a base structure; a plurality of rolling members attached to the base structure and configured to contact and roll across a horizontal surface while remaining attached to the base structure and separating the base structure from the horizontal surface; a frame attached to and extending vertically from the base structure; and a plurality of clamps attached to the frame and configured to secure the reactor tubes in a vertical orientation. The clamps are attached to the frame through corresponding elastomeric members that vibrationally isolate the secured reactor tubes from the frame during the vibrational loading of the reactor tubes. The vibrational loading uses one or more vibrators attached and imparting vibrational energy to a corresponding one or more of the reactor tubes.

In an embodiment: the elastomeric members comprise rubber washers; the one or more vibrators comprise one or more pneumatic ball vibrators; and the rolling members comprise wheels.

In an embodiment, the frame comprises: a plurality of vertical members attached to and extending vertically from the base structure; and a horizontal member between, attached to, and extending horizontally from the vertical members, wherein the clamps are attached to the horizontal member through the corresponding elastomeric members.

In an embodiment: the horizontal member comprises a plurality of horizontal members including a first horizontal member and a second horizontal member below the first horizontal member; the elastomeric members comprise first elastomeric members and second elastomeric members; the clamps comprise first clamps attached to the first horizontal member through corresponding ones of the first elastomeric members, and second clamps attached to the second horizontal member through corresponding ones of the second elastomeric members; and the first clamps are vertically aligned with corresponding ones of the second clamps such that the vertically-aligned pairs of the first and second clamps are configured to secure the reactor tubes in the vertical orientation.

In an embodiment, the base structure comprises a base plate configured to support an operator of the loading station.

In an embodiment: the clamps are further attached to the frame through corresponding clamp bases; and the clamps secure the reactor tubes by separating from and reattaching to the corresponding clamp bases.

In an embodiment: the elastomeric members comprise corresponding rubber washers; and the clamp bases and corresponding rubber washers are attached to each other and to the frame through corresponding bolts.

According to another embodiment, a method of vibrational loading of one or more pilot plant reactor tubes using a portable reactor loading station is provided. The loading station includes a base structure, a plurality of rolling members attached to the base structure and configured to contact and roll across a horizontal surface while remaining attached to the base structure and separating the base structure from the horizontal surface, a frame attached to and extending vertically from the base structure, and one or more clamps attached to the frame through corresponding elastomeric members. The method comprises: rolling the loading station across the horizontal surface and into position using the rolling members; securing the reactor tubes in a vertical orientation using the clamps; vibrating at least one of the reactor tubes using a corresponding at least one vibrator attached and imparting vibrational energy to the at least one of the reactor tubes; loading reactor material into the vibrating at least one of the reactor tubes; and vibrationally isolating the secured reactor tubes from the frame during the vibrational loading using the elastomeric members.

In an embodiment: the elastomeric members comprise one or more rubber washers; the at least one vibrator comprises at least one pneumatic ball vibrator; the rolling members comprise wheels; and the reactor material comprises catalytic material.

In an embodiment, the frame comprises: a plurality of vertical members attached to and extending vertically from the base structure; and a horizontal member between, attached to, and extending horizontally from the vertical members, wherein the clamps are attached to the horizontal member through the corresponding elastomeric members.

In an embodiment: the horizontal member comprises a plurality of horizontal members including a first horizontal member and a second horizontal member below the first horizontal member; the elastomeric members comprise first elastomeric members and second elastomeric members; the clamps comprise first clamps attached to the first horizontal member through corresponding ones of the first elastomeric members, and second clamps attached to the second horizontal member through corresponding ones of the second elastomeric members; the first clamps are vertically aligned with corresponding ones of the second clamps; and securing the reactor tubes further comprises securing the reactor tubes in the vertical orientation using the vertically-aligned pairs of the first and second clamps.

In an embodiment, the method further comprises supporting an operator of the loading station on a base plate of the base structure.

In an embodiment: the clamps are further attached to the frame through corresponding clamp bases; and securing the reactor tubes comprises separating the clamps from and reattaching the clamps to the corresponding clamp bases.

In an embodiment: the elastomeric members comprise corresponding rubber washers; and the clamp bases and corresponding rubber washers are attached to each other and to the frame through corresponding bolts.

According to yet another embodiment, a system for vibrational loading is provided. The system comprises: one or more pilot plant reactor tubes; at least one vibrator attached to, and configured to impart vibrational energy to during the vibrational loading of, a corresponding at least one of the reactor tubes; and a portable reactor loading station. The loading station comprises: a base structure; a plurality of rolling members attached to the base structure and configured to contact and roll across a horizontal surface while remaining attached to the base structure and separating the base structure from the horizontal surface; a frame attached to and extending vertically from the base structure; and one or more clamps attached to the frame and securing the reactor tubes in a vertical orientation, The clamps are attached to the frame through corresponding elastomeric members vibrationally isolating the secured reactor tubes from the frame during the vibrational loading.

In an embodiment: the elastomeric members comprise one or more rubber washers; the at least one vibrator comprises at least one pneumatic ball vibrator; and the rolling members comprise wheels.

In an embodiment, the frame comprises: a plurality of vertical members attached to and extending vertically from the base structure; and a horizontal member between, attached to, and extending horizontally from the vertical members, wherein the clamps are attached to the horizontal member through the corresponding elastomeric members.

In an embodiment: the horizontal member comprises a plurality of horizontal members including a first horizontal member and a second horizontal member below the first horizontal member; the elastomeric members comprise first elastomeric members and second elastomeric members; the clamps comprise first clamps attached to the first horizontal member through corresponding ones of the first elastomeric members, and second clamps attached to the second horizontal member through corresponding ones of the second elastomeric members; and the first clamps are vertically aligned with corresponding ones of the second clamps such that the vertically-aligned pairs of the first and second clamps secure the reactor tubes in the vertical orientation.

In an embodiment, the base structure comprises a base plate configured to support an operator of the system.

In an embodiment: the clamps are further attached to the frame through corresponding clamp bases; and the clamps secure the reactor tubes by separating from and reattaching to the corresponding clamp bases.

In an embodiment: the elastomeric members comprise corresponding rubber washers; and the clamp bases and corresponding rubber washers are attached to each other and to the frame through corresponding bolts.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a perspective diagram of an example portable reactor loading station for vibrational loading of pilot plant reactor tubes, according to an embodiment.

FIG. 2 is a top view of an example clamp attached to a horizontal beam, such as for the portable reactor loading station of FIG. 1, according to an embodiment.

FIG. 3 is a side cutaway view of an example pilot plant reactor tube for use with a portable reactor loading station, such as the portable reactor loading station of FIG. 1, according to an embodiment.

FIG. 4 is a flow chart of an example method of vibrational loading of one or more pilot plant reactor tubes using a portable reactor loading station, such as the portable reactor loading station of FIG. 1, according to an embodiment.

It is noted that the drawings are illustrative and not necessarily to scale.

### DETAILED DESCRIPTION OF CERTAIN EMBODIMENTS OF THE DISCLOSURE

Example embodiments of the present disclosure are directed to a portable reactor loading station for vibrational loading of pilot plant reactor tubes. In one such embodiment, a portable frame is used in the vibrational loading of reactor tubes in laboratory pilot plant reactors. Each reactor (e.g., reactor tube) is clamped to the frame via an elastomeric washer (such as a rubber washer). A pneumatic vibrator (such as a pneumatic ball vibrator) is attached to the reactor. The vibrator imparts controlled horizontally-circular vibrational energy to the pilot plant reactor in order to facilitate repeatable and proper catalyst packing in the reactor tube. The application of controlled vibrational energy results in a uniform and repeatable catalyst packing, which helps reduce or minimize experimental errors in laboratory catalyst testing studies. In another such embodiment, a rigid structural frame incorporating one or more reactor clamps capable of holding pilot plant reactor tubes in a vertical position is provided. The clamps facilitate the loading of the reactor tubes with solid particulates including inert packing and catalyst (or catalytic) material. The rigid structural frame is mounted on rollers or wheels to facilitate the relocation of the frame to different locations based on need or convenience.

As discussed earlier, various commercial scale chemical processes are conducted in continuous flow reactor vessels loaded with a solid catalyst. In these reactors, fluids consisting of gas, liquid, or a mixture of gas and liquid components are fed into the reactor inlet. The fluid flows though the solid catalyst, which causes the chemical components in the feed to chemically convert to products. Catalysts are often proprietary materials developed with a great deal of technical art. Although different catalysts may physically appear the same and may have similar or even identical chemical compositions, performance between such catalysts can vary widely. Even small differences in catalyst performance can have a significant difference in the economic impact of a commercial process. In many instances, the difference between two catalysts is small. However, even a 0.5% difference in performance can provide a significant economic benefit when applied commercially. It is therefore imperative that laboratory test procedures be technically advanced in order to minimize experimental variability, and assure that the observed performance differences between two or more catalysts are statistically significant.

Accordingly, in various embodiments, a portable loading platform for mounting pilot plant chemical reactors is provided. Each reactor includes a horizontally-vibrated vertically-mounted tube connected to a rigid frame via an elastomeric washer. The elastomeric washer allows the reactor to be vibrated without dissipating vibrational energy to the frame and its surroundings (such as other reactors attached to the frame). This vibrational consistency and isolation helps improve the repeatability of catalyst packing in such reactors sharing the same loading station.

In some such embodiments, a portable reactor loading station for vibrational loading of pilot plant reactor tubes is provided. The loading station includes a base structure (or platform), with a plurality of rolling members (e.g., wheels, rollers, casters) attached to the base structure. The rolling members are configured to contact and roll across a horizontal surface (such as a floor) while remaining attached to the base structure, all the while separating the base structure from the horizontal surface and making the loading station portable. The loading station further includes a frame attached to and extending vertically from the base structure, and a plurality of clamps attached to the frame. The clamps are configured to secure the reactor tubes in a vertical orientation, such as for packing with catalyst (or catalytic) material used in a chemical reaction in the reactor tube to produce desired by-products. The clamps are attached to the frame through corresponding elastomeric members (e.g., rubber washers) that vibrationally isolate the secured reactor tubes from the frame during the vibrational loading of the reactor tubes.

Here, the vibrational loading uses one or more vibrators (such as pneumatic ball vibrators) attached and imparting vibrational energy to a corresponding one or more of the reactor tubes. In an embodiment, a reactor tube is loaded (or packed) with different components, including a catalyst, while undergoing vibration from a vibrator, such as a pneumatic ball vibrator.

In an embodiment, a system for vibrational loading (such as for a pilot plant) is provided. The system includes one or more pilot plant reactor tubes, and at least one vibrator attached to, and configured to impart vibrational energy to during the vibrational loading of, a corresponding at least one of the reactor tubes. The system further includes a portable reactor loading station, such as one of those presented throughout this disclosure. The system is compact and vibrates reactor tubes that are, for example, 1.5-3.5 centimeters (cm) in diameter and that are vertically supported. Each reactor is secured using one or more vertically-aligned clamps. Each clamp is attached to a framework with a bolt. The weight of the reactor applies vertical shear stress to the attachment bolt(s). The bolt employs an elastomeric washer, which allows the bolt to vibrate separately from the frame in order to vibrationally isolate each reactor tube from the other reactor tubes (or other external vibration sources). Vibration is applied to each reactor tube in a generally circular and horizontal orientation, such as during loading of the reactor tube with catalyst and other material. The vibration can be varied to improve or optimize the loading based on factors such as the reactor size, dimensions, and type of loading. Vibrational energy is applied directly to the reactor, such as by an attached pneumatic ball vibrator.

Such a system is relatively small and portable, requiring relatively little energy to operate. The system is capable of supporting numerous different reactors being operated concurrently and with consistent catalyst packing between and among multiple reactor experiments. As such, the system is ideal in a pilot plant environment to evaluate the effects of different catalysts with the accuracy and consistency needed to make commercial process decisions. The circular vibrational energy of the system is superior for homogenous reactor packing (such as for pilot plant experiments) compared to the generally linear vibrators used for filling bulk containers.

As discussed herein, a catalyst generally refers to extrudates, formed extrudates, spheres, or irregular granules. Example catalyst particle size is in the range of 2 millimeters (mm) to 8 mm. In order to select the best catalyst for a process, pilot plant testing is conducted. In pilot plant testing, several different candidate catalysts are tested in small diameter laboratory reactors varying from 1 cm to 5 cm in outside diameter and 0.5 meters (m) to 2 m in length. A pilot plant test program consists of comparing the performance of two or more catalysts.

In various embodiments, differences between reactor trials are reduced or minimized by standard experimental best practices such as operator training, calibrated balances, flow controllers, and good operational and quality control practices. In addition to these best practices, pilot plant reactor packing is critical. Relatively speaking, catalyst particles are only slightly smaller than the reactor tube internal diameter. The void spaces near the catalyst wall create wall effects where fluid preferentially flows down the wall and bypasses the catalyst-rich central core. Because of the short reactor length and low fluid velocity relative to a commercial unit, axial dispersion is a concern.

As such, in various embodiments, the catalyst is packed with diluent. Diluent includes low surface area refractory materials such as carborundum, quartz sand, or silicon carbide. Diluent includes fine particulate material with a size distribution that reduces or minimizes wall effects by filling the catalyst voids at the wall, or by filling catalyst interstitial volumes to increase the fluid velocity. In some embodiments, the catalyst and diluent are pre-mixed before loading, by using a mixing funnel. In some other embodiments, the catalyst is packed and then the finer diluent is percolated through the catalyst bed. In many instances, diluent includes angular particles produced by grinding. Diluent particles tend to lock in place when poured into a vessel. As such, some vibration significantly facilitates the pouring and efficient mixing of the diluent particles. Within the context of pilot plant packing this vibration should be done in a repeatable manner to insure repeatable pilot plant test results.

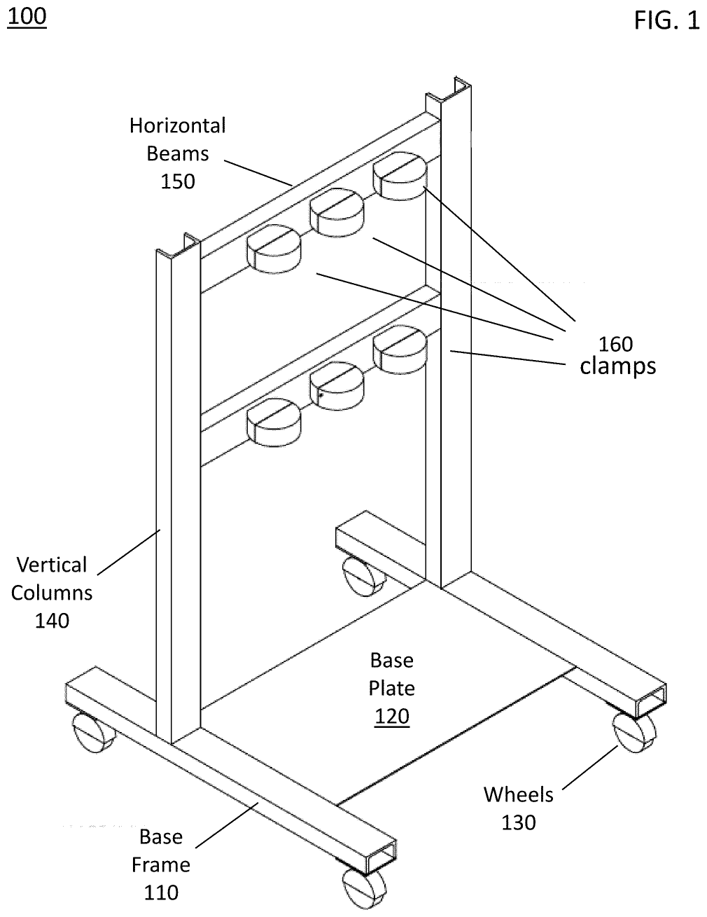

FIG. 1 is a perspective diagram of an example portable reactor loading station 100 for vibrational loading of pilot plant reactor tubes, according to an embodiment. The loading station 100 includes a base structure (or base frame 110 or lower frame) and a main structure (or frame or upper frame). As used herein, terms of orientation such as above and below, lower and upper, and horizontal and vertical, are with respect to the direction of gravity unless otherwise specified.

In further detail, the base structure includes a base frame 110 and a base plate 120 attached to the base frame. The base frame 110 is mounted on wheels 130 for moving the loading station 100 around, such as on a floor or other horizontal surface. The upper frame includes two vertical columns 140 attached to the base frame 110. Between the columns 140, one or more horizontal beams 150 are attached. The columns 140 and horizontal beams 150 are fabricated, for example, from carbon steel channel, I-beams, or angle iron.

The base consists of a base frame 110 for structural integrity upon which a metal (base) plate 120 is attached. The metal plate 120 serves as flooring. During the course of reactor loading operators can step onto the plate 120 for convenience in attaching the reactor tube to the (upper) frame or to facilitate catalyst loading. The plate 120 also serves the function of stiffening the base frame 110. The plate 120 is attached to the base frame 110. It can be attached with, for example, screws, bolts, welding, or any other suitable means. One or more clamps 160 are attached to the horizontal beams 150. The clamps 160 secure the reactor tubes in a vertical (upright) orientation. In some embodiments, such as that shown in the loading station 100 of FIG. 1, there are multiple horizontal beams 150, with the clamps 160 being consistently arranged and vertically aligned (e.g., in columns) on each of the horizontal beams 150. In this fashion, each reactor tube can be secured in a vertical orientation using each of the vertically-aligned clamps 160 of one of the vertical columns of clamps 160.

In one embodiment, the loading station 100 is used as follows. An empty reactor tube closed at the bottom and open at the top is attached to one or more vertically-aligned clamps 160. Each clamp 160 is attached to a separate horizontal beam 150. Various aliquots of diluent packing or catalyst (or catalyst and diluent) are loaded in set or predetermined portions, which are defined, for example, by weight or by the target height in the reactor tube. During the course of the loading, the reactor tube is continuously or periodically vibrated or tapped to impart vibrational energy to the tube contents in order to facilitate the settling of the contents. In some embodiments, for various reasons, it is desirable to percolate catalyst particles, extrudates, or spheres into the reactor. In some embodiments, catalyst particles and silicon carbide diluent are added to the reactor in pre-measured aliquots to build a series of grading and catalyst beds.

In order to achieve good settling, packing, and the like, as each aliquot is loaded, vibrational energy is applied to the reactor tube in order to settle the catalyst or diluent in the reactor tube. The presence of the elastomeric washer acts as a shock absorber to isolate the tube and vibrator from the frame in such a way that the vibrational energy is not otherwise dissipated to the frame and the general surroundings. Because the reactor tube is isolated from the loading platform, the repeatability of the catalyst loading is improved.

Repeatability is important because deficient catalyst loading in the small scales of a pilot plant reactor can skew experimental results. Poor experimental results can lead to a situation where an inferior catalyst is recommended over a superior catalyst for commercial use in a process.

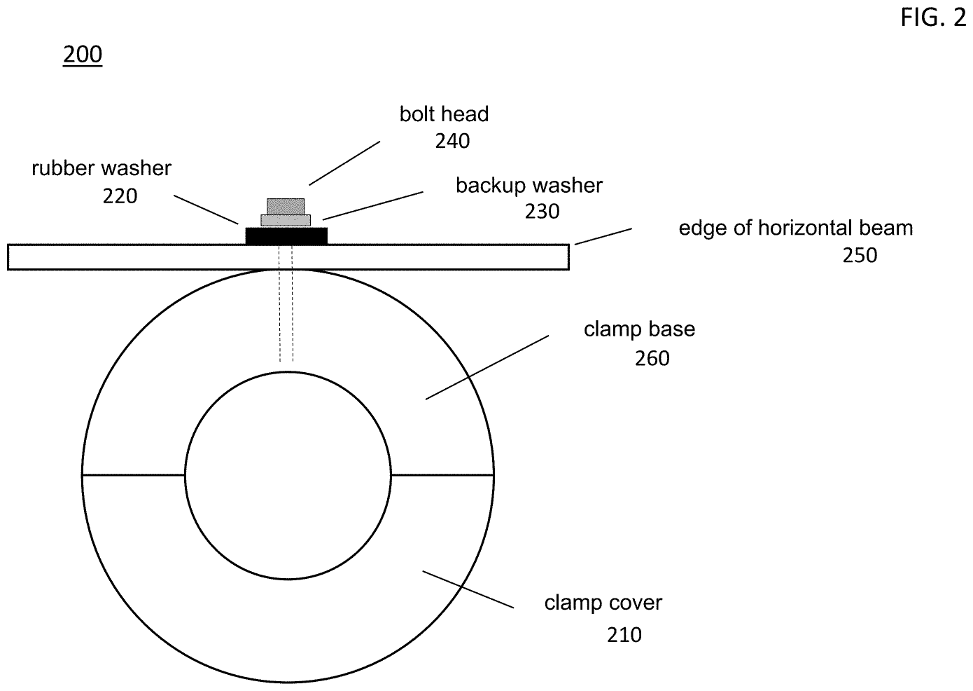

FIG. 2 is a top view of an example clamp 200 attached to a horizontal beam 250, such as for the portable reactor loading station 100 of FIG. 1, according to an embodiment.

Each clamp 200 includes a clamp base 260 that is attached to the horizontal beam 250, and a clamp cover 210 (or simply clamp) which is attached to the clamp base 260 by means of screws, bolts, or other such easily reversible techniques. The clamp base 260 and clamp cover 210 are fabricated in order to accommodate a reactor tube of a fixed diameter, which is held in place when the clamp cover 210 is attached to the clamp base 260. The clamp base 260 is attached to the horizontal beam 250 with, for example, a bolt 240 or a screw.

The head of the bolt 240 is separated from the horizontal beam 250 with a vibrational washer 220 fabricated from rubber. In some embodiments, the rubber washer 220 is 1 mm to 10 mm in thickness and has an internal diameter slightly larger than the bolt diameter. The purpose of the elastomeric washer 220 is to deform elastically when the clamp base 260, clamp cover 210, and attached reactor tube are vibrated during catalyst loading in order to properly and reproducibly percolate and settle the catalyst being loaded into the reactor tube. FIG. 2 illustrates the clamp 200, including horizontal beam 250 connection and the bolt apparatus 240, which further includes a backup washer 230 to increase the effective head size of the bolt 240 as it contacts the elastomeric washer 220.

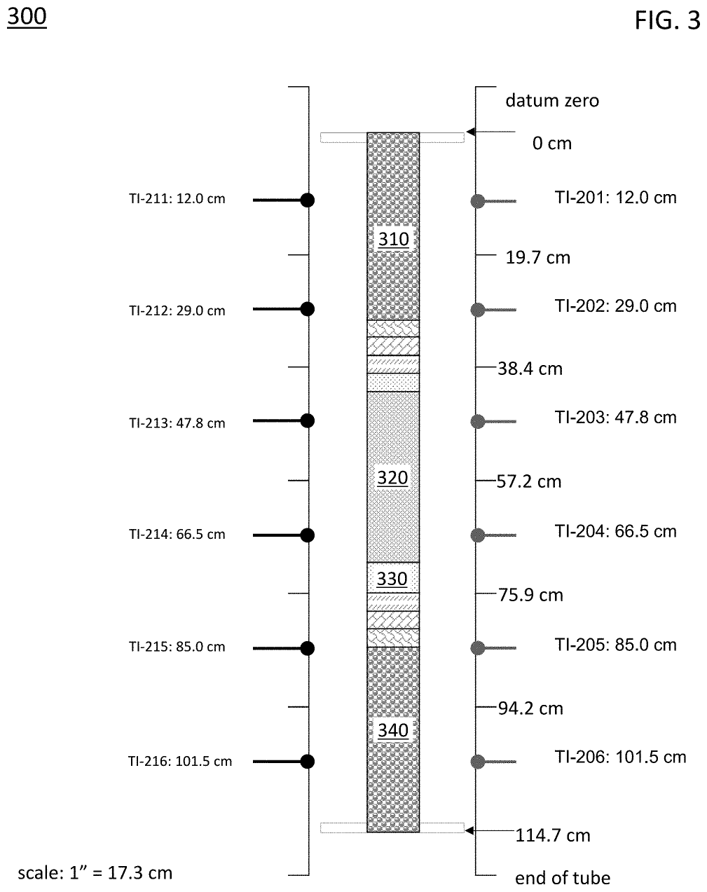

FIG. 3 is a side cutaway view of an example pilot plant reactor tube 300 for use with a portable reactor loading station, such as the portable reactor loading station 100 of FIG. 1, according to an embodiment. In FIG. 3, various fill heights (or depths) are illustrated for different layers that make up a reactor. In some embodiments, the different layers are fabricated using packing. In FIG. 3, eleven such layers are present, with four of them labeled (from top to bottom, or last to first in packing order) 310, 320, 330, and 340.

In further detail, during packing, the reactor tube 300 is filled with assorted beds of glass beads, ceramic balls, diluent, and catalyst. A schematic of a completed catalyst loading is presented in FIG. 3. In FIG. 3, the catalyst is the central bed 320. Beds above and beds below are grading and include, for example, ceramic balls and various size grades of diluent ranging from coarse to fine. For instance, the first bed 340 and the last bed 310 define the end and the beginning portions, respectively, of the chemical reaction, while preceding bed 330 is the bed formed right before the catalyst bed 320. The locations (e.g., heights) of various external skin thermocouples and internal reactor thermocouples are also presented in FIG. 3.

In various embodiments, the reactor tube 300 is securely clamped in a vertical position or orientation. The bottom of the tube is closed and a funnel is placed at the top. It is important that the tube is securely clamped because there may be various wires, tube stubs, fittings, and the like, extending from the bottom of the tube. If the tube were to fall during packing these connections would be damaged.

In the packing process, various beds are poured through the funnel into the reactor 300. At various times, the reactor tube 300 is tapped or otherwise vibrated. It can be continuously vibrated, or after each bed is loaded. In some cases, it may be beneficial to not vibrate until a series of beds have been loaded. But in any event, the fact that the reactor tube is securely clamped is a hinderance because vibrational energy applied to the reactor tube is dissipated through the clamp and to whatever the frame, wall, or the like, to which the clamps are attached.

Mallet tapping can impart the required energy to the reactor tube to settle and percolate the catalyst, even when the tube is clamped. However, there are disadvantages to tapping because the vibrational energy is not applied uniformly or in a repeatable manner. Vibration can be performed by a variety of ways. It may be as simple as tapping on the reactor tube with a mallet or by attaching a vibrator to the reactor tube. Mallet tapping is difficult to specify. Operators tend to hold a mallet in their right hand and tap from right to left. Tapping a reactor tube from the right will cause the catalyst inside the tube to jump to the left which opens a gap between the tube inside wall and catalyst. Diluent then falls into the gap. The result is that there is preferentially less catalyst along the wall of the catalyst that is oriented to the right. The catalyst is not properly distributed across the reactor cross section. This will reduce the apparent activity of the catalyst in testing and will increase experimental variability because it cannot be easily duplicated.

An alternative to tapping is to load the reactor 300 on a vibrating table. A vibration table consists of a steel plate mounted or attached to a frame through shock absorbers. Furthermore, a motor-driven vibrator is attached to the table. A vibrating table is fitted with a clamping mechanism to hold the reactor tube vertically for loading. The clamping mechanism is mounted on a platform which is positioned on top of a series of springs. Vibrational energy is applied to the clamping mechanism or the platform, which facilitates the settling of the catalyst and diluent. Vibration tables are used in the loading of particles into barrels or boxes. The apparatus works well enough, but it is not compact for laboratories that do not have the required space.

Various types of vibrators are used in packing. Different vibrators impart different amounts of energy, and the energy is produced in different geometric modes. In the simple case of a mallet, a mallet transfers one dimensional horizontally polarized vibration energy to an object consisting of one dimensional side-to-side motion. Other vibrators can supply one dimensional vertically polarized motion

In various embodiments, a pneumatic ball vibrator is used. The pneumatic ball vibrator imparts circular vibration. A pneumatic ball vibrator includes a steel ball rotating in an enclosed circular channel, which is enclosed in the vibrator housing. As the ball rotates, the center of gravity changes in a circular pattern. This transfers circularly polarized vibration energy to the vibrator and to any objects in contact with the vibrator, such as the reactor tube and catalyst. Based on the orientation of the vibrator with the objects, the circular polarized energy can be horizontally polarized or vertically polarized (or some variation of the two depending on the axis of vibration).

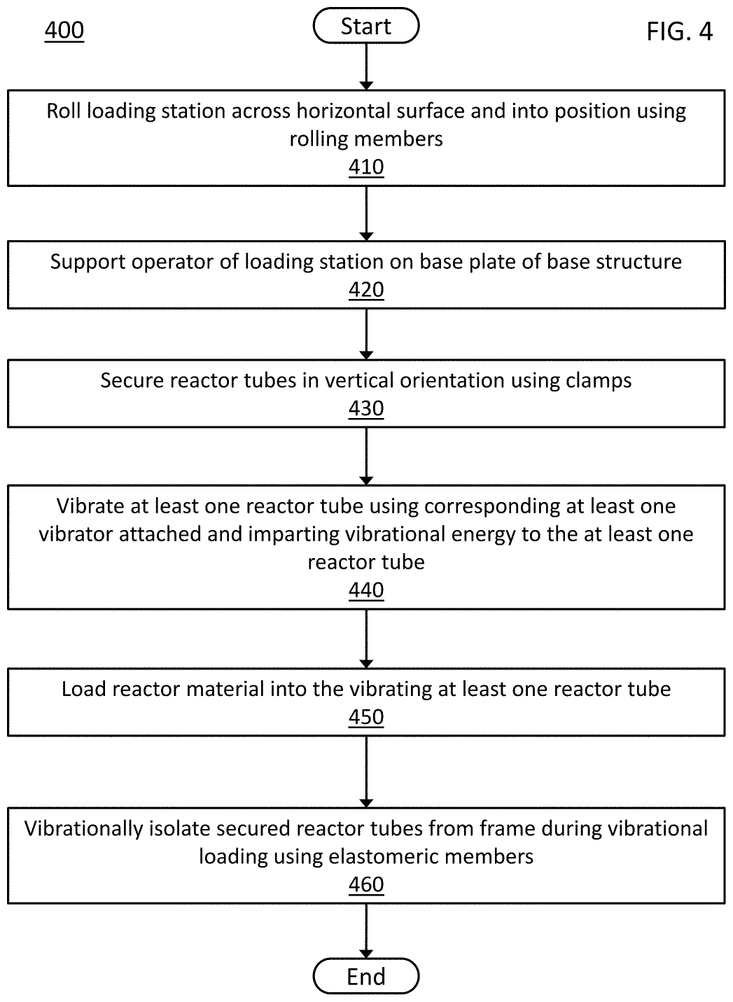

FIG. 4 is a flow chart of an example method 400 of vibrational loading of one or more pilot plant reactor tubes (such as reactor tube 300) using a portable reactor loading station, such as the portable reactor loading station 100 of FIG. 1, according to an embodiment. The loading station includes a base structure (such as base frame 110), and a plurality of rolling members (such as wheels 130) attached to the base structure and configured to contact and roll across a horizontal surface (such as a floor) while remaining attached to the base structure and while separating the base structure from the horizontal surface. The loading station also includes a frame (such as vertical columns 140 and horizontal beams 150) attached to and extending vertically from the base structure, and one or more clamps (such as clamps 160 or 200) attached to the frame through corresponding elastomeric members (such as rubber washer 220).

Some or all of the method 400 can be performed using components and techniques illustrated in FIGS. 1-3. Portions of this and other methods disclosed herein can be performed on or using a custom or preprogrammed logic device, circuit, or processor, such as a programmable logic circuit (PLC), computer, software, or other circuit (e.g., ASIC, FPGA) configured by code or logic to carry out their assigned task. The device, circuit, or processor can be, for example, a dedicated or shared hardware device (such as a laptop, a workstation, a tablet, a smartphone, part of a server, or a dedicated hardware circuit, as in an FPGA or ASIC, or the like), or computer server, or a portion of a server or computer system. The device, circuit, or processor can include a non-transitory computer readable medium (CRM, such as read-only memory (ROM), flash drive, or disk drive) storing instructions that, when executed on one or more processors, cause portions of the method 400 (or other disclosed method) to be carried out. It should be noted that in other embodiments, the order of the operations can be varied, and that some of the operations can be omitted.

In the example method 400, processing begins with the step of rolling 410 the loading station across the horizontal surface and into position using the rolling members. The method 400 further includes the step of supporting 420 an operator of the loading station on a base plate (such as base plate 120) of the base structure. The method 400 further includes the step of securing 430 the reactor tubes (such as reactor tube 300) in a vertical orientation using the clamps. The method 400 further includes the step of vibrating 440 at least one of the reactor tubes using a corresponding at least one vibrator (such as a pneumatic ball vibrator) attached and imparting vibrational energy to the at least one of the reactor tubes. The method 400 further includes the step of loading 450 reactor material (such as catalyst or catalytic material, as in catalyst 320) into the vibrating at least one of the reactor tubes. The method 400 further includes the step of vibrationally isolating 460 the secured reactor tubes from the frame during the vibrational loading using the elastomeric members.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the scope of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A portable reactor loading station for vibrational loading of pilot plant reactor tubes, the loading station comprising:
a base structure;
a plurality of rolling members attached to the base structure and configured to contact and roll across a horizontal surface while remaining attached to the base structure, the rolling members separate the base structure from the horizontal surface;
a frame attached to and extending vertically from the base structure; and
a plurality of clamps attached to the frame and configured to secure the reactor tubes in a vertical orientation,
wherein the clamps are attached to the frame through corresponding elastomeric members that vibrationally isolate the secured reactor tubes from the frame during the vibrational loading of the reactor tubes, the vibrational loading using one or more vibrators attached and imparting vibrational energy to a corresponding one or more of the reactor tubes.

2. The loading station of claim 1, wherein:
the elastomeric members comprise rubber washers;
the one or more vibrators comprise one or more pneumatic ball vibrators; and
the rolling members comprise wheels.

3. The loading station of claim 1, wherein the frame comprises:
a plurality of vertical members attached to and extending vertically from the base structure; and
a horizontal member between, attached to, and extending horizontally from the vertical members,
wherein the clamps are attached to the horizontal member through the corresponding elastomeric members.

4. The loading station of claim 3, wherein:
the horizontal member comprises a plurality of horizontal members including a first horizontal member and a second horizontal member below the first horizontal member;
the elastomeric members comprise first elastomeric members and second elastomeric members;
the clamps comprise first clamps attached to the first horizontal member through corresponding ones of the first elastomeric members, and second clamps attached to the second horizontal member through corresponding ones of the second elastomeric members; and
the first clamps are vertically aligned with corresponding ones of the second clamps such that the vertically-aligned pairs of the first and second clamps are configured to secure the reactor tubes in the vertical orientation.

5. The loading station of claim 1, wherein the base structure comprises a base plate configured to support an operator of the loading station.

6. The loading station of claim 1, wherein:
the clamps are further attached to the frame through corresponding clamp bases; and
the clamps secure the reactor tubes by separating from and reattaching to the corresponding clamp bases.

7. The loading station of claim 6, wherein:
the elastomeric members comprise corresponding rubber washers; and
the clamp bases and corresponding rubber washers are attached to each other and to the frame through corresponding bolts.

8. A method of vibrational loading of one or more pilot plant reactor tubes using a portable reactor loading station, the loading station including a base structure, a plurality of rolling members attached to the base structure and configured to contact and roll across a horizontal surface while remaining attached to the base structure and separating the base structure from the horizontal surface, a frame attached to and extending vertically from the base structure, and one or more clamps attached to the frame through corresponding elastomeric members, the method comprising:
rolling the loading station across the horizontal surface and into position using the rolling members;
securing the reactor tubes in a vertical orientation using the clamps;
vibrating at least one of the reactor tubes using a corresponding at least one vibrator attached and imparting vibrational energy to the at least one of the reactor tubes;
loading reactor material into the vibrating at least one of the reactor tubes; and
vibrationally isolating the secured reactor tubes from the frame during the vibrational loading using the elastomeric members.

9. The method of claim 8, wherein:
the elastomeric members comprise one or more rubber washers;
the at least one vibrator comprises at least one pneumatic ball vibrator;
the rolling members comprise wheels; and
the reactor material comprises catalytic material.

10. The method of claim 8, wherein the frame comprises:
a plurality of vertical members attached to and extending vertically from the base structure; and
a horizontal member between, attached to, and extending horizontally from the vertical members,
wherein the clamps are attached to the horizontal member through the corresponding elastomeric members.

11. The method of claim 10, wherein:
the horizontal member comprises a plurality of horizontal members including a first horizontal member and a second horizontal member below the first horizontal member;
the elastomeric members comprise first elastomeric members and second elastomeric members;
the clamps comprise first clamps attached to the first horizontal member through corresponding ones of the first elastomeric members, and second clamps attached to the second horizontal member through corresponding ones of the second elastomeric members;
the first clamps are vertically aligned with corresponding ones of the second clamps; and
securing the reactor tubes further comprises securing the reactor tubes in the vertical orientation using the vertically-aligned pairs of the first and second clamps.

12. The method of claim 8, further comprising supporting an operator of the loading station on a base plate of the base structure.

13. The method of claim 8, wherein:
the clamps are further attached to the frame through corresponding clamp bases; and
securing the reactor tubes comprises separating the clamps from and reattaching the clamps to the corresponding clamp bases.

14. The method of claim 13, wherein:
the elastomeric members comprise corresponding rubber washers; and
the clamp bases and corresponding rubber washers are attached to each other and to the frame through corresponding bolts.

15. A system for vibrational loading, the system comprising:
one or more pilot plant reactor tubes;
at least one vibrator attached to, and configured to impart vibrational energy to during the vibrational loading of, a corresponding at least one of the reactor tubes; and
a portable reactor loading station comprising:
a base structure;
a plurality of rolling members attached to the base structure and configured to contact and roll across a horizontal surface while remaining attached to the base structure and separating the base structure from the horizontal surface;
a frame attached to and extending vertically from the base structure; and
one or more clamps attached to the frame and securing the reactor tubes in a vertical orientation,
wherein the clamps are attached to the frame through corresponding elastomeric members vibrationally isolating the secured reactor tubes from the frame during the vibrational loading.

16. The system of claim 15, wherein:
the elastomeric members comprise one or more rubber washers;
the at least one vibrator comprises at least one pneumatic ball vibrator; and
the rolling members comprise wheels.

17. The system of claim 15, wherein the frame comprises:
a plurality of vertical members attached to and extending vertically from the base structure; and
a horizontal member between, attached to, and extending horizontally from the vertical members,
wherein the clamps are attached to the horizontal member through the corresponding elastomeric members.

18. The system of claim 17, wherein:
the horizontal member comprises a plurality of horizontal members including a first horizontal member and a second horizontal member below the first horizontal member;
the elastomeric members comprise first elastomeric members and second elastomeric members;
the clamps comprise first clamps attached to the first horizontal member through corresponding ones of the first elastomeric members, and second clamps attached to the second horizontal member through corresponding ones of the second elastomeric members; and
the first clamps are vertically aligned with corresponding ones of the second clamps such that the vertically-aligned pairs of the first and second clamps secure the reactor tubes in the vertical orientation.

19. The system of claim 15, wherein the base structure comprises a base plate configured to support an operator of the system.

20. The system of claim 15, wherein:
the clamps are further attached to the frame through corresponding clamp bases; and
the clamps secure the reactor tubes by separating from and reattaching to the corresponding clamp bases.

21. The system of claim 20, wherein:
the elastomeric members comprise corresponding rubber washers; and
the clamp bases and corresponding rubber washers are attached to each other and to the frame through corresponding bolts.
